(19) United States
(12) Patent Application Publication
(10) Pub. No.: US 2010/0012078 A1
(43) Pub. Date: Jan. 21, 2010

(54) IC ENGINE WITH MOBILE COMBUSTION CHAMBER

(75) Inventors: Aldo Cerruti, Lainate (IT); Romano Murri, Roma (IT); Marzia Murri, Roma (IT)

Correspondence Address: AKERMAN SENTERFITT, P.O. BOX 3188, WEST PALM BEACH, FL, 33402-3188, US

(73) Assignee: Aldo CERRUTI, Lainate (IT)

(21) Appl. No.: 11/721,918

(22) PCT Filed: Dec. 20, 2005
(86) PCT No.: PCT/IB2005/003828

§ 371 Date: Oct. 7, 2009

(30) Foreign Application Priority Data
Dec. 20, 2004 (IT) RM2004A000623

(51) Int. Cl. F02B 53/00

(52) U.S. Cl. 123/244

(57) ABSTRACT

The engine according to the invention comprises: a) a casing (12) inside which an annular cavity is formed; b) an annular rotor (14), housed within the annular cavity; c) multiple mobile chamber elements (10), secured to the rotor (14). The annular cavity has, in some regions, cross-sectional sizes substantially greater than the cross-sectional sizes of the rotor (14) so as to define multiple hollow chambers relative to the annular body of the rotor (14) while contacting the walls of the same annular cavity and separating in fluid-tight manner the hollow chamber portion in front of the mobile chamber element (10) from the hollow chamber portion be hind the mobile chamber element (10).

### FIELD OF THE INVENTION

The present invention concerns an element for internal combustion engine, which can have the combined functions of a compression chamber, a combustion chamber, a valve, a member defining the portions with cyclically variable volume, a device for translating compressed gases.

### STATE OF THE ART

State of the art: neither internal combustion engines of the above type, nor elements similar to or comparable with the “mobile chamber” exist.

It is an object of the present invention to provide an alternative to the presently known internal combustion engines.

### SUMMARY OF THE INVENTION

The above object is achieved, according to the present invention, by an internal combustion engine having the features of claim 1.

According to a second aspect of the present invention, the above object is achieved by an element for an internal combustion engine having the features of claim 16.

According to a preferred embodiment, such an element for an internal combustion engine is capable of defining regions with cyclically variable volume during the rotation of the toroidal element it is connected to.

According to a preferred embodiment, such an element for an internal combustion engine includes, or consists of, a single body and accessory members (such as sealing members, motion guiding members, mixture igniting members, and so on).

According to a preferred embodiment, such an element for an internal combustion engine includes, or consists of, several parts assembled so as to be relatively movable or stationary, and accessory members, if any.

According to a preferred embodiment, such an element for an internal combustion engine is radially slidable (for accomplishing its task) relative to the toroidal element inside the casing.

According to a preferred embodiment, such an element for an internal combustion engine is laterally slidable relative to the toroidal element.

According to a preferred embodiment, such an element for an internal combustion engine is capable of effecting one or more composite movements radially and/or laterally relative to the toroidal element.

According to a preferred embodiment, such an element for an internal combustion engine is pivotally connected to the toroidal element and is angularly movable, or also angularly movable, relative to the toroidal element.

According to a preferred embodiment, such an element for an internal combustion engine includes a structure or a fitting capable of varying the internal volumetric capacity thereof.

According to a preferred embodiment, such an element for an internal combustion engine is connected to a device provided on the casing, e.g. a guide or the like, conditioning its movement relative to the torus or other rotating element during rotation.

The advantages of the present invention will become more apparent from the following detailed description, given only by way of non-limiting example with reference to the following schematic Figures, of some embodiments of an engine according to the present invention.

### LIST OF THE FIGURES

FIG. 1 is a view, taken in a direction parallel to an axis A, of a first embodiment of an internal combustion engine according to the present invention;

FIG. 2 is a cross-sectional view, according to a section plane passing through axis A, of the rotor of the engine of FIG. 1;

FIG. 3 is a cross-sectional view, according to a section plane passing through axis A, of the cavity for the sliding movement, of a mobile chamber element and of a toroidal element located within said duct, both elements belonging to the engine of FIG. 1;

FIG. 4 is a cross-sectional view, according to a section plane passing through axis A, of the cavity for the sliding movement and of the toroidal element of FIG. 3, as seen from the opposite side to that of FIG. 3;

FIGS. 5, 6 and 7 are a cross-sectional side view, a front view and a perspective view, respectively, of a mobile chamber element of the engine of FIG. 1;

FIG. 8 is a longitudinal cross-sectional view of a mobile chamber of the engine of FIG. 1;

FIGS. 9 and 10 show two details of the longitudinal cross-sectional view of FIG. 8, in two different instants and with the mobile chamber element in two different positions;

FIG. 11 is a cross-sectional view, taken in a direction parallel to an axis A, of a second embodiment of an internal combustion engine according to the present invention;

FIG. 12 is a cross-sectional view, taken in a direction parallel to an axis A, of a third embodiment of an internal combustion engine according to the present invention.

### DETAILED DESCRIPTION

A rotor or toroidal element 14 is located within a housing or casing 12 and adheres thereto at some regions, whereas at other regions, corresponding to angular portions of the torus rotation, ie. corresponding to one or more predetermined circular sectors of torus 14, the rotor is spaced apart from said casing 12 thereby defining hollow chambers.

Otherwise stated, rotor 14, of substantially toroidal shape, is housed within an annular cavity formed inside a housing or casing 12. The shape of the annular cavity does not exactly correspond to the shape of rotor 14, but it has a greater cross-sectional size in certain regions so as to define said hollow chambers, which are defined by parts of the walls of rotor 14, of the annular casing cavity and of the moving chamber elements disclosed hereinafter.

Said hollow chambers can be e.g. symmetrically arranged internally and externally of torus 14, relative to rotation axis A, or to the left or the right of the torus, as well as internally and on one side, or even externally and on one side or even internally, externally, on one side and on the opposite side at the same time. This will become more apparent from the following description of one of the possible embodiments of the device.

Element 10 according to the present patent is a single-piece element or is possibly made of multiple pieces, and it must be capable of adhering to the surfaces outside torus 14 and the cavity provided therein, so as to allow a radial, a lateral or a combined movement of said elements.

Rotation of torus 14 about its axis A will result, through the displacement of said elements, in the creation of two or more chambers with cyclically variable volume, which chambers are formed by the internal surface of casing 12, the external surface of torus 14 and both the internal and the external surfaces of one or more elements 10. The latter are referred to, in the present description, as “mobile chamber elements 10”. Said mobile chamber elements 10, during rotation of torus 14 about axis A, move along the surface of casing 12 according to a positively actuated motion, which may be natural or also induced by a fixed guide and in any case is such as to allow the correct element operation. Namely, the radially innermost or outermost walls of the casing chambers, where rotor 14 moves, act as cam profiles, whereas mobile chamber elements 10 act as the driven elements of a cam-operated system.

In the embodiment shown in FIGS. 3, 4 and 8, while rotor 14 rotates, the walls of the annular casing cavity displace mobile chamber elements 10 parallel to rotation axis A of the rotor itself.

“Mobile chambers” 10, two in the present description, but whose number could even be different, form the element allowing first gas suction, then gas compression, the translation of the compressed gas to a chamber outside torus 14, on the side opposed to said chamber. There, gas ignition and then gas burst will take place, and the gases, by pressing against “mobile chamber” 10, will make torus 14 rotate about its axis A, while allowing at the same time execution of the four strokes of a four-stroke engine in the chambers or portions thereof defined as disclosed above.

Reference numeral 34 in the Figures denotes an ignition device, such as a spark plug, capable of causing ignition of the combustible gas mixture present in a suitable region of the annular cavity inside casing 12. In the embodiments shown in the accompanying Figures, the combustible gas mixture is ignited by a spark plug 34 when it is compressed in a hollow chamber.

The assembly of such a motor could even be referred to as a “delimited-chamber turbine”, but the severe energy loss of the turbines probably would not do justice to such kind of motor.

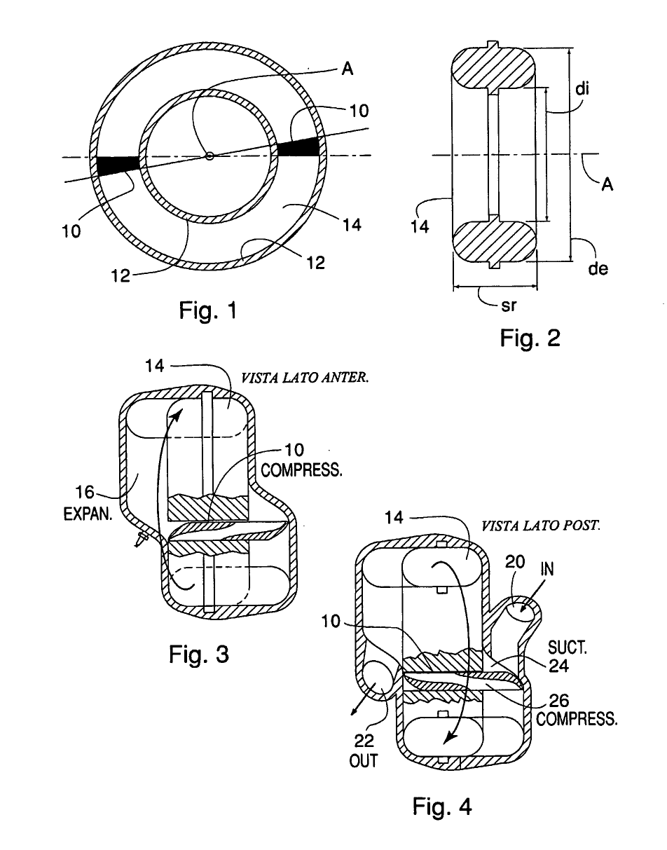

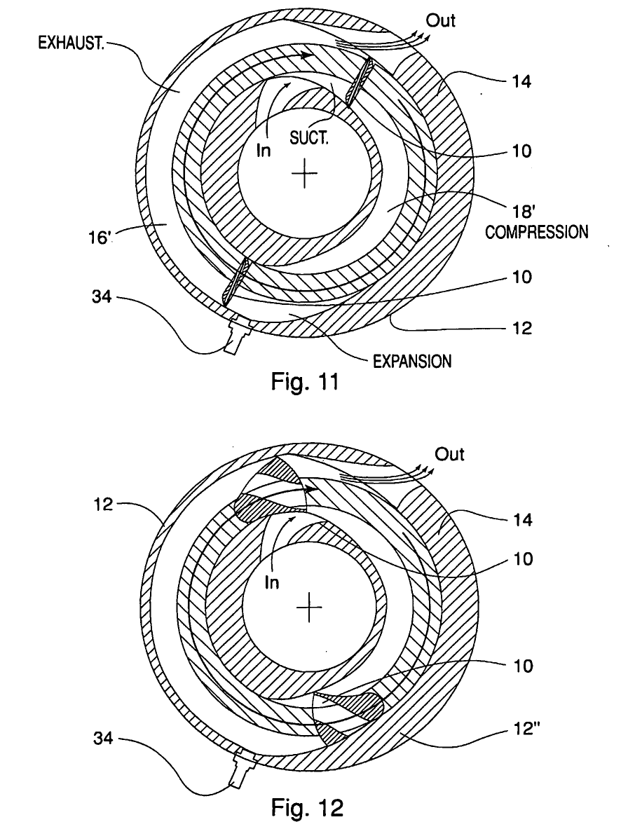

The accompanying Figures show some possible constructive solutions for mobile chambers 10, given only for explanatory purposes of the possible embodiments of the invention, without any limiting intention. There are shown laterally slidable chambers 10 (FIGS. 1 to 10), i.e. chambers slidable e.g. in a direction parallel to rotation axis A of rotor 14, or radially slidable chambers (FIG. 11) or yet pivotally mounted chambers (FIG. 12, i.e. chambers which are fastened to rotor 14 by means of a pivot pin 34, so that they can radially oscillate). All chambers have the functions of “piston”, intended as a pushing member, “valve”, due to the possibility of opening and closing internal flow paths, compression chamber, or at least a part thereof, combustion chamber, or at least a part thereof, and basic member for translating gases relative to a toroidal element 14 forming the basic engine structure.

The operation of the engine according to the embodiment shown in FIG. 11 is as follows. When rotor 14 rotates, a mobile chamber element 10 defines, together with the walls of a mobile chamber in the annular casing cavity, a chamber with increasing variable volume, and causes suction of air or a gas mixture from suction duct IN (legend ASP in FIG. 11). When performing suction, rotor 14 closes a port in the passage inside element 10 itself, thereby preventing, apart from leaks, important gas flows from upstream to downstream the concerned element 10 through internal passage 28 thereof. While rotor 14 continues rotating, mobile chamber element 10 and the walls of the annular cavity form a chamber with progressively decreasing variable volume and compress the sucked gases (legend COMP in FIG. 11). At the proper instant, mobile chamber element 10 is progressively spaced apart from the walls of the annular cavity, in radial direction towards the outside of the same annular chamber, as long as both end ports of internal passage 28 begin to open: thus, the sucked gases is allowed to flow, at least in part, from the hollow chamber located on the radially internal side of rotor 14 to another hollow chamber located on the radially external side of rotor 14 (legend ESP in FIG. 11). When mobile chamber element 10 is radially displaced towards the outside of rotor 14, so that the latter closes one port in passage 28, the passage of combustible gases between hollow chamber COMP and hollow chamber ESP is thereby prevented. Subsequently, ignition spark plug 34 ignites the combustible gas mixture present in hollow chamber ESP and causes gas explosion. The burnt gas mixture expands in chamber ESP and provides further energy for the rotation of rotor 14. While further continuing rotating, rotor 14 pushes the combusted gases through annular cavity portion SCAR and then through exhaust port OUT. The combustion cycle just disclosed is repeated substantially identically for the other mobile chamber elements 10 of the rotor.

Namely, referring to a unit wherein mobile chambers 10 laterally move relative to torus 14, hence parallel to rotation axis A thereof, the function of each chamber will be, starting from the suction phase: defining a cyclically variable space formed by the internal surface of casing 12, by the external surface of torus 14 and by mobile chamber 10 or by the portion thereof extending into said space. On its rear side, with reference to the rotation direction, the chamber makes the hollow volume of the structure increase and hence provides for a natural suction. A the same time, the front portion, with reference to the rotation direction, compresses the gases sucked because of the passage of previous moving chamber 10. Hence, for the whole duration of that phase, suction and compression take place simultaneously. Yet, should the engine have two diametrically opposite mobile chambers 10, chamber 10 located on the opposite side of the first one will be effecting the pushing or explosion phase on its rear side and will be effecting the burnt gas exhaust phase on the other side. In this case, the engine could be defined a four-stroke 4/4 engine, this denoting that the four strokes of the Otto cycle simultaneously occur, like in a conventional four-cylinder engine with cranks arranged at 180°.

The solution allows constructing an engine formed by a casing (or housing) 12 containing a toroidal ring 14 and two mobile chambers 10, in the whole, three mobile members (besides, of course, the sealing members, the electrical fittings and so on).

Rotor 14 may be connected for instance to an output shaft (not shown), by which the motive power generated by the engine can be transferred to the outside.

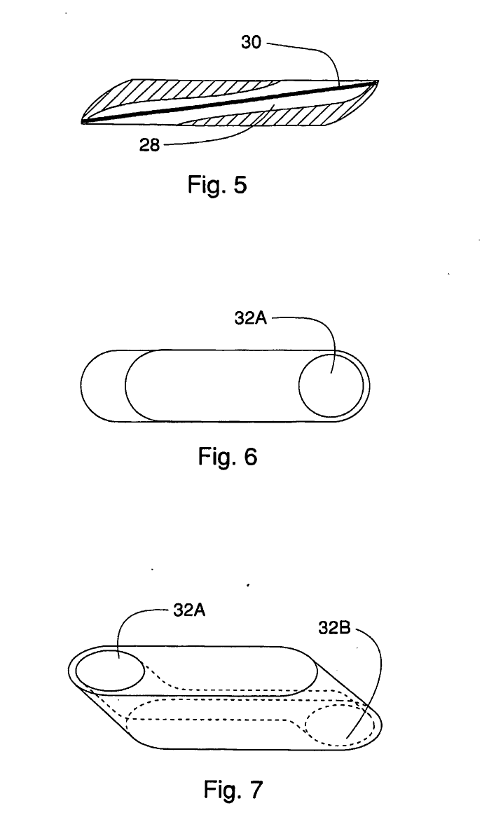

In the embodiment shown in FIG. 5, reference numeral 30 denotes a sealing member, capable of limiting leakage of fluids present inside the annular cavity between mobile chamber element 10 and the walls of the same annular cavity. A sealing member 30 may be for instance a compression ring, a set of compression rings or one or more gaskets provided around and outside mobile chamber element 10.

The essential components of said kind of engine are the mobile chambers 10 determining the cyclical variability of the internal chambers and the fluid passage from one side to the other of the torus and through the chamber structure.

Until now monolithic mobile chambers 10 have been assumed, that is chambers substantially made of a single piece. Yet, should this be deemed more convenient, the same chambers could comprise multiple parts, possibly connected to each other, and/or could be internally provided with devices capable of varying the chamber volume, and hence the compression ratio, or of promoting the thrust in the optimum direction.

The accompanying Figures show the features of some solutions according to the invention for explanatory purposes and without any limiting character. In FIG. 1 and the following Figures:
10 denotes the mobile chamber
12 denotes the casing
14 denotes the rotor (toroid)
DI denotes the internal torus diameter;
DE denotes the external torus diameter;
SR denotes the rotor (or torus) cross-section.
FIG. 3 is a view of the part facing the viewer of an engine according to the present invention; there:
EXPANS denotes the region where gas expansion takes place upon the explosion;
COMPRESS denotes the region where sucked gas compression occurs, partly inside moving chamber 10.

FIG. 4 is a view of the opposite part, in which:
IN denotes the suction duct;
OUT denotes the exhaust duct;
SUCT denotes the region where gas suction occurs;
COMPRESS denotes the region where sucked gas compression occurs;
10 denotes the mobile chamber.

FIG. 5 is a longitudinal cross-sectional view of a mobile chamber 10, where:
28 denotes the space inside the chamber suitable for gas translation, said space being also referred to in the present description as “passage 28”; reference numerals 32 in FIG. 7 denote the two end ports of passage 28, through which the passage communicates with the outside of mobile chamber element 10;
30 denotes a sealing member.

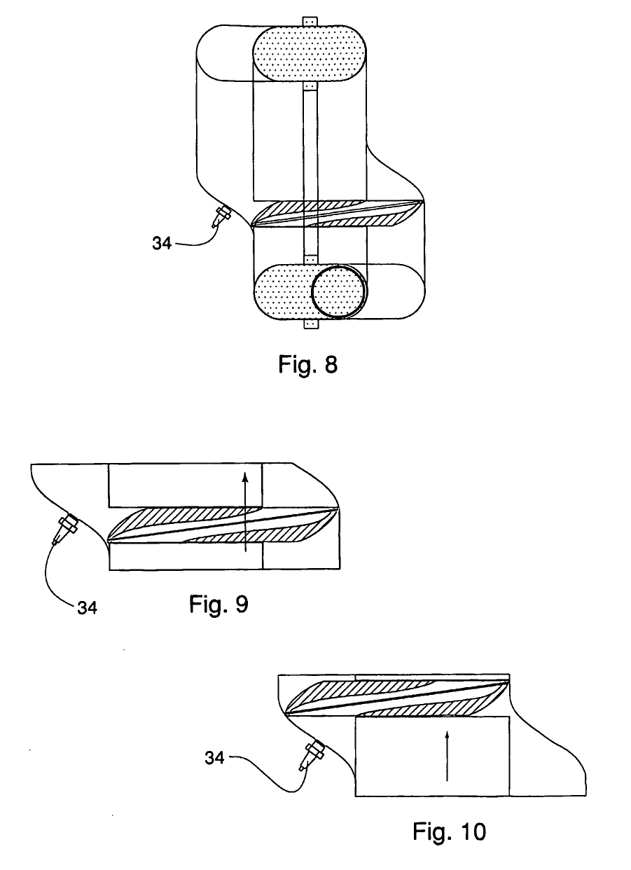

FIG. 6 is a plan view of mobile chamber 10 and FIG. 7 is a three-dimensional view thereof, where 32 denotes the outlet point of the internal duct. FIGS. 8, 9 and 10 show the same elements in different positions.

FIG. 11 is a plan view of a radial engine, with mobile chambers 10′ radially slidable in their seats provided in rotor 14.

FIG. 12 is a plan view of a radial engine, with mobile chambers 10″ angularly movable about a pivot point 34; the other reference symbols are as already described.

The above description has been given only in order to explain the subject matter of the patent and its functionality. Where the description refers to limiting features of said subject matter, the same features must never be intended as elements limiting the constructional extent, but merely as features characterising one among the several possible embodiments or characterising the element of which the “operation intelligence” will become apparent, beyond the embodiments assumed and included in the description.

1. An internal combustion engine, comprising:
a casing inside which a substantially annular cavity is formed;
a substantially annular rotor, housed within the annular cavity;
at least one mobile chamber element secured to the rotor;
wherein the annular cavity has, at least in a portion thereof, cross sections substantially greater than the cross sections of the rotor so as to define at least one hollow chamber;
wherein, within at least part of the at least one hollow chamber, the at least one mobile chamber element can be displaced at least along the rotation axis of the rotor itself while contacting the walls of the same annular cavity and thereby separating in fluid-tight manner the hollow chamber portion in front of the mobile chamber element from the hollow chamber portion behind the mobile chamber element.

2. The engine as claimed in claim 1, comprising a plurality of hollow chambers.

3. The engine as claimed in claim 1, comprising a plurality of mobile chamber elements 3.

4. The engine as claimed in claim 1, wherein the at least one mobile chamber element is displaceable, in correspondence of the at least one mobile chamber, in at least one direction along the rotation axis of the rotor and has, along the at least one direction along the rotation axis of the rotor, a size substantially greater than the cross-sectional size of the rotor.

5. The engine as claimed in claim 1, wherein the at least one mobile chamber element has a passage extending through the mobile chamber element from one end to the opposite one and ending with two ports, and wherein, in at least one operating condition:
one port is closed by either the rotor or the external casing, thereby substantially preventing fluids present in the hollow chamber portion in front of the mobile chamber element from flowing into the hollow chamber portion behind the mobile chamber element or, conversely, preventing fluids present in the hollow chamber portion behind the mobile chamber element from flowing into the hollow chamber portion in front of the mobile chamber element; and
the other port is open, whereby fluids present in either the hollow chamber portion behind the mobile chamber element or the hollow chamber portion in front of the mobile chamber element can enter said port.

6. The engine as claimed in claim 1, wherein the at least one mobile chamber element has a passage extending through the mobile chamber element from one end to the opposite one and ending with two ports, and wherein, in at least one operating condition, both ports are open, thereby allowing fluids present in the hollow chamber portion behind the mobile chamber element to flow into the hollow chamber portion in front of the mobile chamber element or, conversely, allowing fluids present in the hollow chamber portion in front of the mobile chamber element to flow into the hollow chamber portion behind the mobile chamber element.

7. The engine as claimed in claim 1, wherein the at least one mobile chamber element is fastened to the rotor so that it can be at least translatable relative to the rotor, preferably in a direction along the rotation axis of the rotor.

8. The engine as claimed in claim 1, wherein the at least one mobile chamber element is fastened to the rotor so as to be at least rotatable relative thereto, preferably by displacing at least one part of the same element in a direction along the rotation axis of the rotor.

9. The engine as claimed in claim 1, wherein the displacements of the at least one mobile chamber element can be driven by the walls of the annular chamber and/or by other casing portions.

10. The engine as claimed in claim 9, wherein the walls of the annular chamber and/or the other casing portions are arranged to drive the displacements of the at least one mobile chamber element by pushing the latter substantially like a cam profile.

11. The engine as claimed in claim 1, wherein the casing, the rotor and the at least one mobile chamber element are arranged to form at least one chamber having a variable volume increasing with the rotation of the rotor and arranged to suck a fluid into the casing.

12. The engine as claimed in claim 1, wherein the casing, the rotor and the at least one mobile chamber element are arranged to form at least one chamber having a variable volume decreasing with the rotation of rotor and arranged to compress a fluid present inside the casing.

13. The engine as claimed in claim 1, comprising an ignition device arranged to ignite a fluid present inside the casing.

14. An internal combustion engine, comprising:
a casing inside which a substantially annular cavity is formed;
a substantially annular rotor, housed within the annular cavity;
at least one mobile chamber element secured to the rotor;
wherein the annular cavity has, at least in a portion thereof, cross sections substantially greater than the cross sections of the rotor so as to define at least one hollow chamber;
wherein, within at least part of the at least one hollow chamber, the at least one mobile chamber element is fastened to the rotor so as to be at least rotatable relative thereto, preferably by displacing at least one part of the same element in a direction transversal to the annular body of the rotor, while contacting the walls of the same annular cavity and thereby separating in fluid-tight manner the hollow chamber portion in front of the mobile chamber element from the hollow chamber portion behind the mobile chamber element.
